(19) United States
(12) Patent Application Publication
(10) Pub. No.: US 2005/0184084 A1
(43) Pub. Date: Aug. 25, 2005

(54) Systems and methods of fluid distribution

(76) Inventor: Bruce J. Wells, Centennial, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/784,052

(22) Filed: Feb. 19, 2004

(51) Int. Cl. G01F 11/00

(52) U.S. Cl. 222/1

(57) ABSTRACT

Embodiments of the invention provide novel containers, systems, methods and software products to facilitate efficient delivery, packaging and/or dispensing of fluids, and in particular, industrial fluids. Such industrial fluids can include, without limitation, petroleum-based fluids, automotive fluids, industrial lubricants, cutting fluids, cooling fluids, and the like. In accordance with certain embodiments of the invention, fluids may be delivered in transportable and/or ready-to-dispense containers, eliminating the need for expensive, custom delivery solutions. Advantageously, therefore, such containers may be delivered using general purpose delivery vehicles, allowing delivery to be outsourced to a third party (if desired), and reducing the capital expenditures and operating costs fluid suppliers experience in securing delivery of their supplied fluids. Moreover, receipt of fluids packaged in such containers allows the users of fluids to forego expensive equipment installation and provides a more flexible environment for the use of fluids.

### BACKGROUND OF THE INVENTION

The present application relates generally to the distribution of fluids, and specifically to methods and systems for distributing such fluids.

There are many uses of industrial fluids. For example, manufacturing industries often use industrial fluids to lubricate manufacturing equipment, as coolant in cutting operation, and the like. Similarly, in the automotive industry, vehicle service centers use a variety of fluids in the repair and/or maintenance of vehicles.

Generally if a user consumes such fluids in any substantial quantity, the user prefers to receive the fluids in bulk form, in order to realize cost savings in supply and delivery costs, reduce container waste, and the like. Merely by way of example, an automotive repair shop might maintain an underground (or aboveground) bulk storage tank for motor oil, and might contract with an oil supplier for delivery of bulk oil to that tank on a periodic or as-needed basis.

The receipt of fluids in bulk, however, presents several problems, for both the fluid supplier and the user of those fluids. For example, the installation and/or maintenance of facilities for storing and/or dispensing bulk fluids generally are relatively expensive, requiring a substantial outlay of initial capital to install the facilities as well as period costs to maintain the facilities. Further, the user generally must purchase the fluid at the time of delivery, even though most of the fluid may not be used for some time, tying up additional capital that could be better used in other ways. In addition, fluid stored in bulk tanks is difficult to use, requiring specialized equipment to transfer a usable quantity of the fluid from the bulk tank to the location in which is the fluid is to be used. For example, many users of bulk fluids use hoses incorporated within hose reels, such as those available from Samoa Industrial, S.A. of Gijon, Spain, to deliver fluids from bulk tanks to the location of use. Such reel systems, however, are often expensive, and they do not allow the use of fluids in locations outside the reach of the hoses. Moreover, such hose reels require bulk tank systems, including pumps, pipes and reels, and therefore normally are used only for fluids consumed in relatively high volumes—other fluids are generally purchased in individualized containers, imposing higher per-unit costs on the supplier and/or user. Additionally, such installed systems are normally considered, for tax purposes, appurtenances to the property on which they are installed, requiring lengthy amortization and other unfavorable tax treatment. Those skilled in the art will appreciate that such classification of these systems also hinders the fluid supplier's ability to lease (or provide other favorable terms towards the user's acquisition of) the systems.

Alternatively, a user may pump a limited quantity of a fluid from a bulk tank into a portable cart, which the user then transports to the use location. Such carts, examples of which are also available from Samoa Industrial, are generally inefficient, however, because they must be refilled periodically, requiring additional trips between the tank location and the use location. Moreover, neither the hose reels nor the mobile carts can mitigate the costs to both the supplier and the user associated with the delivery and/or storage of bulk fluids.

Bulk delivery of fluids also presents other limitations for the fluid supplier. Generally, bulk fluids must be transported in specialized trucks with large tanks, requiring the fluid supplier to operate and maintain a fleet of such trucks, along with the personnel to operate the fleet. An article in the May 2001 issue of Compoundings magazine, written by Thomas F. Glenn and entitled “What Does It ‘Really’ Cost To Deliver A Gallon Of Lubricant?” (the entirety of which is incorporated herein by reference for all purposes), describes many of the costs facing fluid suppliers. This problem is exacerbated for the supplier in the case of small and mid-sized users, who may require fluids in quantities insufficient to justify delivery by tank truck. Such users, moreover, may be situated in remote locations, often requiring a long, expensive trip for the truck to deliver a relatively modest amount of the supplied fluid.

Thus, there is a need for novel systems and methods for delivering and/or dispensing fluids, and particularly industrial fluids.

### BRIEF SUMMARY OF THE INVENTION

Embodiments of the invention provide novel containers, systems, methods and software products to facilitate efficient packaging, delivery and/or dispensing of fluids, and in particular, industrial fluids. Such industrial fluids can include, without limitation, petroleum-based fluids, automotive fluids, industrial lubricants, cutting fluids, cooling fluids, and the like. In accordance with certain embodiments of the invention, fluids may be delivered in transportable and/or ready-to-dispense containers, eliminating the need for expensive, custom delivery solutions. Advantageously, therefore, such containers may be delivered using general purpose delivery vehicles, allowing delivery to be outsourced to a third party (if desired), and reducing the capital expenditures and operating costs fluid suppliers experience in securing delivery of their supplied fluids. Moreover, receipt of fluids packaged in such containers allows the users of fluids to forego expensive equipment installation and provides a more flexible environment for the use of fluids.

In accordance with certain aspects of the invention, a fluid container may be configured to be coupled to a fluid delivery station, which can be mobile and/or capable of locomotion, allowing the user to position the fluid delivery station in an optimal location for the dispensation of fluids and/or to move the delivery station among various locations, providing flexible dispensing options for the user. In accordance with some embodiments, the fluid station can be configured to communicate with a control terminal, which can serve to authorize the dispensation of fluids and/or account for fluids dispensed. The control terminal, which may be (but need not be) situated at the user's location, can also be configured to communicate with the fluid supplier. In this way, fluid can be accounted for as it is dispensed, if desired. Further, fluid consumption by a machine may thus be monitored, and problems such as leaks, over-consumption, etc. (which may indicate a machine failure) can be monitored by the user and/or supplier.

Merely by way of example, in accordance with some embodiments, the fluid may be owned by the supplier even after delivery, and ownership of the fluid may be transferred to the user only upon dispensation from the fluid container. This may allow the user increased financial flexibility, since the user need not pay for the fluid in bulk. Additionally, the dispensed fluid may be measured and monitored, and the amount of fluid remaining in the container calculated, so that an order for one or more additional container(s) of fluid may be recorded automatically upon reaching a certain threshold amount of fluid dispensed from the container and/or remaining in the container.

One set of embodiments, therefore, provides fluid containers that may be used for the delivery and/or dispensation of fluids. Merely by way of example, an exemplary embodiment provides a fluid container, which may be transportable and which can be used in a relationship between a fluid supplier and a user of fluids. The exemplary fluid container can be used for delivering a fluid from the fluid supplier to the user. The fluid container can be configured to be transported by a general-purpose delivery vehicle, if desired. The fluid container can also be configured to contain therein a fluid that may be dispensed by the user. The fluid may be an industrial fluid, which can include, inter alia, a petroleum-based fluid, a lubricant for a vehicle, a cutting fluid, and/or the like.

In some embodiments, the transportable fluid container further can be configured to be placed in fluid communication with a fluid distribution station, including without limitation those stations described below. Thus, the user may dispense a first amount of fluid from the transportable fluid container using the fluid distribution station, and, in some cases, the first amount of fluid dispensed from the transportable fluid container may be measured and accounted for separately from a second amount of fluid remaining in the transportable fluid container. Optionally, ownership of the first amount of fluid dispensed from the transportable fluid container can be transferred from the fluid supplier to the user, while ownership of the second amount of fluid remaining in the transportable fluid container can remain with the fluid supplier.

In particular embodiments, the fluid container may comprise a fluid displacement mechanism, which can be configured to be coupled to the fluid distribution station, thereby providing fluid communication between the fluid container and the station. The fluid displacement mechanism can be operable to dispense fluid from the fluid container via the fluid distribution station. In other embodiments, the fluid container may be associated with an identifier, which can be configured to identify the container and/or the fluid contained within the container.

Another set of embodiments provides fluid distribution stations, which can be configured to dispense at least one fluid. An exemplary fluid distribution station can comprise a connecting mechanism for providing fluid communication between the fluid distribution station and one or more fluid container(s). The fluid container(s) may be similar to the fluid containers described above and hereinafter. The fluid distribution station may further comprise a fluid displacement mechanism configured to transfer an amount of fluid from one of the container(s) and/or fluid measurement device for measuring the amount of fluid transferred from the container. The fluid measurement device may comprise an impulse flow meter, a scale, etc.

In some cases, the fluid displacement mechanism may operate using a pressurized gas. The fluid distribution station may also feature an attachment mechanism configured to provide fluid communication between an external source of pressurized gas and one or more of the fluid container(s). Alternatively and/or in addition, the fluid distribution station may be further configured to be in fluid communication with an additional container having contained therein a supply of pressurized gas. The fluid distribution station can be operable to provide fluid communication between the additional container and one or more of the fluid container(s), and the fluid displacement mechanism, therefore, can operate using this supply of pressurized gas.

The distribution station may also include a communication system operable to transmit information about the fluid transferred from the fluid container. In some cases, the communication system can comprise a radio frequency (“RF”) antenna. In certain embodiments, the fluid distribution station can further comprise a control system, which can include a processor and/or instructions executable by the processor to receive from the fluid measurement device data about the fluid transferred from the fluid container(s). In other embodiments, the control system can comprise further instructions for transmitting to a control terminal via the communication system data about the fluid transferred from the fluid container(s) and/or instructions for receiving from a control terminal an authorization to dispense an amount of fluid from one or more of the fluid container(s).

A further set of embodiments provides systems for distributing fluids. One such exemplary system can be used in a relationship between a fluid supplier and a user, and the system can comprise one or more fluid container(s), which may be transportable and/or may be similar to the fluid containers described herein. Some systems can also include fluid distribution stations, which likewise can be similar to those stations described herein. In accordance with some embodiments, the fluid distribution station can be configured to dispense an amount of fluid from the fluid container(s) and/or determine/measure the amount of fluid being dispensed from the fluid container(s). The station can be further configured to transmit information about the dispensed fluid.

In some embodiments, the system can further include a computer system in communication with the fluid distribution station. The computer system can be incorporated within the fluid distribution station and/or a control terminal remote from the fluid distribution station. The computer system can comprise a processor and/or instructions executable by the processor to receive the information about the dispensed fluid and/or account for the dispensed fluid. Accounting for the fluid dispensed can comprise, inter alia, any of the accounting procedures described below.

Further embodiments of the invention include computer software products for facilitating the distribution of industrial fluids and/or computers executing such software products. The software may be embodied on a computer readable medium and may include instructions executable by a computer processor to perform any of the methods and/or functions described herein. Merely by way of example, some computer software products can include instructions executable by a processor to receive information about a fluid being dispensed from a fluid distribution station and/or fluid container, including without limitation those described elsewhere herein. The instructions can further be executable to determine the amount of fluid dispensed from the fluid distribution station/container, transmit information about the dispensed fluid and/or account for the dispensed fluid. At least part of the software product may be configured to be executed on a processor incorporated in a fluid distribution station, a control terminal (which can be located at a facility operated by the user) and/or a server (which can be operated by the fluid supplier).

Another set of embodiments includes methods of distributing and/or dispensing fluids, which can be, inter alia, any of the industrial fluids described herein. One exemplary method of distributing an industrial fluid, which can be used in a relationship between a fluid supplier and a user, comprises providing at the user's location a fluid container (which can be transportable). The fluid container can have contained therein an industrial fluid, and/or the fluid container and/or the industrial fluid can be owned by the fluid supplier. In some cases, providing the fluid container can comprise transporting the fluid container to the user's location while the container has contained therein the industrial fluid.

The method can further comprise allowing the user to dispense an amount of industrial fluid from the transportable fluid container and/or, as the amount of industrial fluid is being dispensed from the fluid container, determining the amount of industrial fluid dispensed. The method can also include accounting for the fluid dispensed from the transportable fluid container, which can comprise, inter alia, any of the procedures described herein for accounting for the fluid. Merely by way of example, accounting for the dispensed fluid can comprise transferring from the fluid supplier ownership of the dispensed fluid, transmitting to the fluid supplier information about the dispensed fluid, billing the user for the dispensed fluid, determining an amount of fluid remaining in the fluid container(s) and/or, if the amount of fluid remaining in the container is less than a threshold value, recording an order for additional industrial fluid and/or recording an order for an additional fluid container having contained therein the additional industrial fluid. As another example, accounting for the dispensed fluid can include determining whether a machine using the dispensed fluid is operating properly.

A method in accordance with other embodiments can comprise providing a fluid distribution station at the user's location, and the fluid distribution station can be configured to be coupled with one or more fluid container(s). In some cases, providing the fluid distribution station can comprise leasing the fluid distribution station to the user. In other cases, the fluid distribution station may be mobile and/or may comprise means for locomotion. The method can further comprise providing at least one fluid container having disposed therein a fluid for distribution and/or coupling the fluid container(s) with the fluid distribution station, such that the fluid distribution station and the container(s) are in fluid communication. In some cases, the fluid and/or the container(s) can be owned by the fluid supplier.

In some embodiments, the method can further comprise allowing the user to dispense an amount of fluid from the fluid container(s), e.g., by using the fluid distribution station, and/or, as the fluid is being dispensed, determining with the fluid distribution station the amount of fluid dispensed from the fluid container(s). The method can also include communicating to the fluid supplier information about the fluid dispensed from the fluid container(s) and/or transferring ownership of the dispensed fluid from the fluid supplier. Moreover, the method can include determining an amount of fluid remaining in the fluid container(s) based on the amount of fluid dispensed from the fluid container(s) and/or communicating to the fluid supplier the amount of fluid remaining in the fluid container.

A control terminal may also be provided, and the control terminal can be in communication with the fluid distribution station. The control terminal, therefore, can be configured to received data from the fluid distribution station about the fluid dispensed from the fluid container(s). Thus, communicating to the fluid supplier information about the fluid dispensed from the fluid container can comprise transmitting from the fluid distribution station data about the fluid dispensed from the fluid container, receiving at the control terminal the data about the fluid dispensed from the fluid container, and/or transmitting from the control terminal to the fluid supplier the data about the fluid dispensed from the fluid container. Alternatively and/or in addition, an authorization to dispense fluid from the fluid container may be transmitted from the control terminal. The authorization may specify an amount of fluid to be dispensed, and/or a request for authorization may be transmitted from the fluid distribution station.

In accordance with yet further embodiments of the invention, a method of dispensing an industrial fluid may comprise providing a fluid distribution station, which can be configured to be coupled with one or more fluid containers. The method can further include coupling one or more fluid container(s) (which may be transportable) with the fluid distribution station, such that the station an the fluid container(s) are in fluid communication. The fluid container(s) can have contained therein one or more industrial fluid(s) owned by a fluid supplier. Fluid may be dispensed from the fluid container(s), perhaps by using the fluid distribution station, and/or as the fluid is being dispensed, the amount of fluid dispensed can be determined. Further, information about the fluid dispensed can be transmitted to a computer remote from the fluid distribution station. In some cases, a second container may be coupled with the fluid distribution station and/or pressurized with a gas. The gas may also be dispensed from the second container, and/or the gas may serve as a source of pressure for dispensing the industrial fluid.

The invention has been summarized briefly above. Those skilled in the art may ascertain additional benefits and features attendant to various embodiments of the invention by reference to the Figures, which are described in detail below, and to the remaining disclosure, which describes those Figures in detail.

### BRIEF DESCRIPTION OF THE DRAWINGS

The figures illustrate one or more exemplary embodiments of the invention, which are described in detail in the remaining portions of the specification. In the figures, like reference numerals are used throughout to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 illustrates a system for distributing and/or dispensing fluids, in accordance with various embodiments of the invention.

FIG. 2 is a generalized schematic illustration of a computer system, which may be used in the distribution and/or dispensation of fluids, in accordance with various embodiments of the invention.

FIG. 3A is a perspective drawing of a fluid distribution station, in accordance with various embodiments of the invention.

FIG. 3B is a generalized schematic drawing illustrating a processor for controlling a fluid distribution station and/or a fluid container, in accordance with embodiments of the invention.

FIG. 4 is a generalized schematic drawing of a system for dispensing fluid from a fluid container, in accordance with various embodiments of the invention.

FIG. 5 is a generalized schematic drawing of a system for providing a pressurized gas to displace fluid from a fluid container, in accordance with various embodiments of the invention.

FIGS. 6A and 6B illustrate the exterior of a transportable fluid container in accordance with embodiments of the invention.

FIG. 7 is a process flow diagram illustrating an exemplary method for dispensing a fluid, in accordance with embodiments of the invention.

### DETAILED DESCRIPTION OF THE INVENTION

Various detailed embodiments of the present invention are disclosed below; one skilled in the art should understood, however, that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed structure.

Among other things, embodiments of the present invention provide systems and methods for delivering and/or dispensing fluids. Although various embodiments of the invention may be suitable for delivery and/or dispensation of any type of fluid, one skilled in the art will appreciate, based on the disclosure herein, that certain embodiments are particularly appropriate for delivering and/or dispensing (sometimes collectively referred to herein as “distributing”) industrial fluids. As used herein, the term “industrial fluid” can mean any type of fluid that may be delivered for use in bulk form, including without limitation in industrial, manufacturing and/or automotive applications. Merely by way of example, industrial fluids used in automotive applications can include, inter alia, fuels, motor oils (synthetic, petroleum-based), coolants, transmission fluids, power steering fluids, windshield washer fluids, etc. Exemplary fluids used in industrial and/or manufacturing applications can include without limitation machine lubricants, coolants, cutting fluids, machining fluids, solvents, dilutants, cleaning fluids, manufacturing chemicals, reagents, and/or the like. In many (but by no means all) cases, industrial fluids can be petroleum-based.

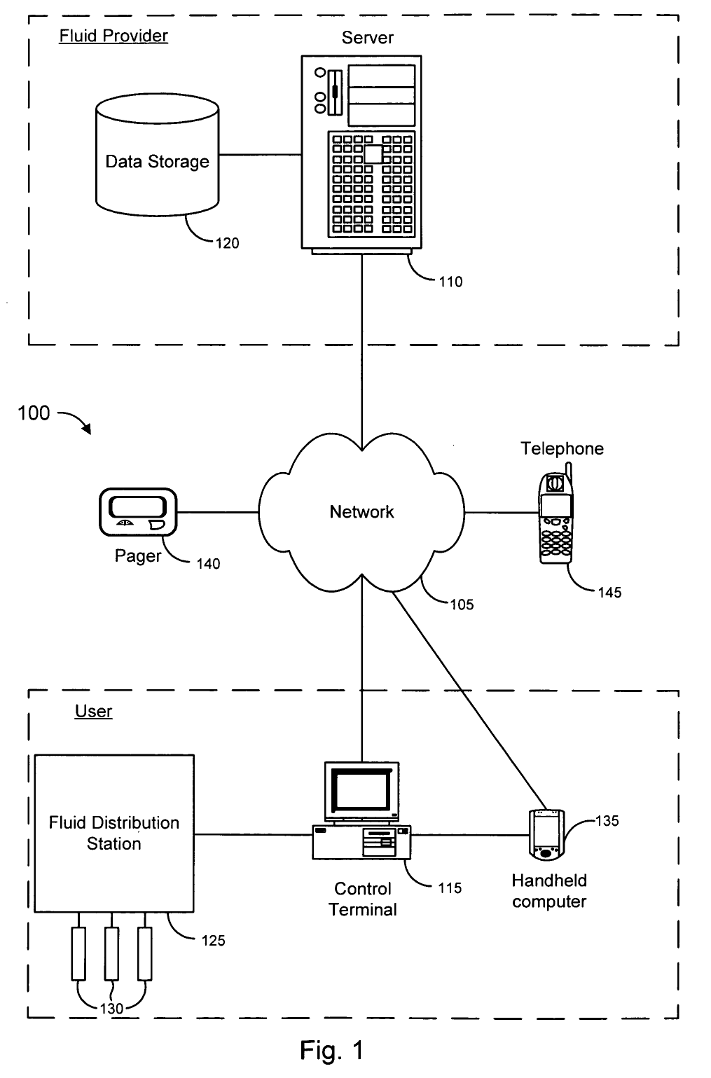

Turning now to FIG. 1, some embodiments of the invention provide systems for distributing fluids, and system 100 can be considered exemplary of some such systems. The exemplary system 100 can utilize a network 105. The network 105 can be any type of network familiar to those skilled in the art that can support data communications using any of a variety of commercially-available protocols, including without limitation TCP/IP, SNA, IPX, AppleTalk, and the like. Merely by way of example, the network 105 can be a local area network (“LAN”), including without limitation an Ethernet network, a Token-Ring network and/or the like; a wide-area network; a virtual network, including without limitation a virtual private network (“VPN”); the Internet; an intranet; an extranet; a telephone network, including without limitation a public switched telephone network (“PSTN”), a wireless telephone network, a private branch exchange (“PBX”) and/or the like; an infra-red network; a wireless network, including without limitation a radio frequency (“RF”) and/or microwave network, such as a network operating under any of the IEEE 802.11 suite of protocols, the Bluetooth™ protocol known in the art, frequency modulation (“FM”) band transmission, shortwave transmission, and/or any other wireless protocol; and/or any combination of these and/or other networks.

In particular embodiments, the network 105 may comprise a PSTN, wherein device communicate with one another via telephone call, sometimes via intermediation by modem. The network 105 may provide continuous, periodic and/or as-needed communication between various devices. It should be noted as well that, although for ease of illustration, only one unified network is illustrated, a plurality of networks (which may be in communication with one another) may be utilized to provide communications between different devices.

The system 100 can also include a variety of devices, which can be in communication with one another, either directly (e.g., via serial connect, parallel connection, etc.) and/or via the network 105. For example, the system 100 illustrated by FIG. 1 includes a server computer 110 and a control terminal 115, which may be in communication via the network 105. In the illustrated embodiment, the server 110 is be situated at a fluid provider's location, and the control terminal 115 is located at the user's location. The physical locations of these devices, however, are discretionary and therefore may vary in other embodiments. For instance, the control terminal 115 may be located at the fluid supplier's location and/or the server 110 may be located at the user's location. In some embodiments, the functionality (described in detail below) of both the server 110 and the control terminal 115 may be incorporated into a single computer.

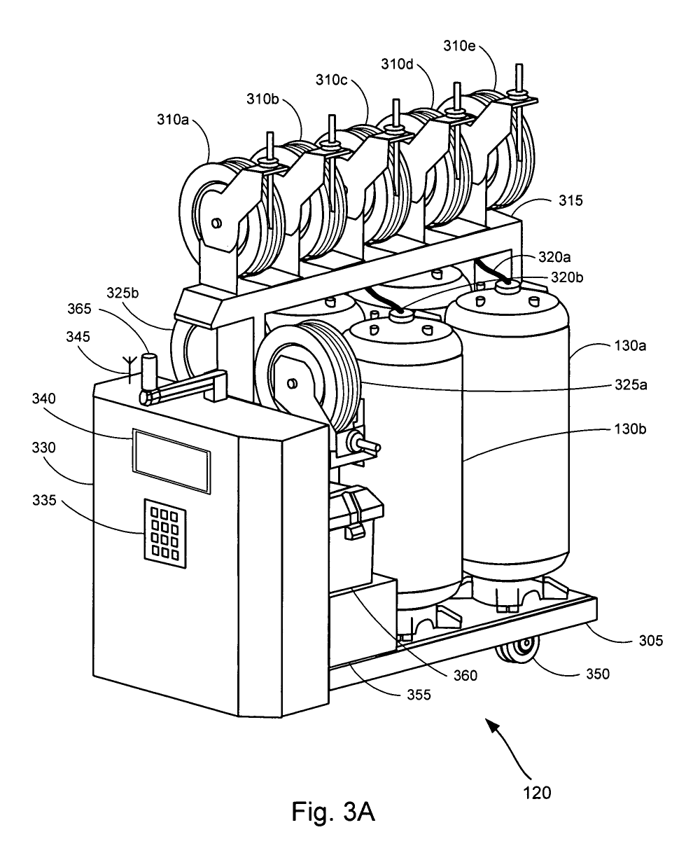

The server, as described in more detail below, can allow the fluid supplier to monitor and/or account for fluid dispensed using the system 100, and can have any hardware and/or software configuration commonly used by those skilled in the art. Merely by way of example, a server 110 may incorporate one or more of the components described in detail with respect to FIG. 3, infra. The server 110 can be programmed with any suitable operating system, including without limitation any of those discussed below, as well as any commercially-available server operating systems, including, merely by way of example, OS/390™, OS/400™, VMS™, UNIX™ (including any of its varieties and/or similar variants), and the like. The server 110 can also run a any server applications necessary to provide communication with the control terminal 115 and/or other devices; such applications can include including HTTP servers, FTP servers, CGI servers, database servers, Java servers, and the like. In particular, the server 110 can be encoded with any necessary communications and/or database software to allow the server 110 to receive information from, and/or transmit instructions/information to, the control terminal 115.

Merely by way of example, the server 110 can include one or more applications accessible by a the control terminal 115 (or another device, such as a client computer, not illustrated on FIG. 1 but familiar to those skilled in the art, a telephone, a pager, a wireless device, and the like). Merely by way of example, the server 110 can be comprise or more general purpose computers capable of executing programs or scripts in response to requests from and/or interaction with client devices, including without limitation web applications. Such web applications can be implemented as one or more scripts or programs written in any programming language, including merely by way of example, C, C++, Java™, COBOL, or any scripting language, such as Perl, Python, or TCL, or any combination thereof. Such web applications can be used to access information about fluid distribution, authorize distribution, record orders for additional fluid(s), configure the server 110, and the like.

As mentioned above, the server 110 can also include database server software, including without limitation packages commercially available from Oracle™, Microsoft™, Sybase™, IBM™ and the like, which can process requests from database clients running on a client device (which may be the control terminal 115). The database software can be used to manage a database of fluid users, fluids delivered and/or dispensed, fluid inventory, delivery schedules and/or the like. The database may be incorporated within a storage device 120, which can comprise one or more hard drives, databases, etc. FIG. 1 depicts the storage device 120 as located proximate to the server 110, as this location generally provides for efficient operation of the system 100, but the location of the storage device 120 is discretionary: it can reside on a storage medium local to (and/or resident in) one or more of the server 110, the control terminal and/or other devices. Alternatively, the storage device 120 can be remote from any or all of these device, so long as it is in communication (e.g., via the network 105) with one or more of these. In some embodiments, the storage device 120 can comprise a storage-area network (“SAN”) familiar to those skilled in the art.

In some implementations, the server 110 may include a telephone interface, which can allow the server to interact with an ordinary (POTS) telephone. The telephone interface, which may be implemented in software and/or hardware embodied in the server 110 and/or in a separate device in communication with the server, can provide integrated voice response (“IVR”) features familiar to those skilled in the art. The telephone interface also can be configured to interpret dual tone multi-frequency (“DTMF”) tones as data input. Thus, in accordance with embodiments of the invention, the telephone interface 115 can allow for a user and/or administrator to interact with a server 110 via voice and/or DTMF commands. Thus, for example, a user may request a delivery of fluid by calling the server 110 and submitting voice and/or DTMF commands. Alternatively, the user may place a request by using a web browser communicating with the server and/or by communicating a request through the control terminal 115. In still other embodiments, as described in detail below, the control terminal 115 may be configured to record an order automatically for additional fluid by contacting the server 110.

The control terminal 115 can be in communication with a fluid distribution station 125. The communication between the control terminal 115 and the fluid distribution station 120 may be direct and/or via the network 105 (and/or a private subset of the network 105, such as a LAN and/or VPN). In particular embodiments, the communication between the control terminal 115 and the fluid distribution station 120 (and/or fluid container 130) may be wireless, including without limitation via any of the wireless communication methods discussed above. Merely by way of example, the communication between the control terminal and the fluid distribution station/fluid container can comprise a spread-spectrum RF transmission (utilizing any necessary hardware known in the art, such as repeaters, etc. to facilitate the transmission). In other embodiments, the communication may be via a solid medium, such as a serial link, an Ethernet link, an IEEE 1394 link, etc.

The fluid distribution station 120, which is described in detail with respect to FIGS. 3-5, can be coupled with one or more fluid containers 130, each of which contains therein one or more industrial fluids to be dispensed by the user. (As used herein, the term “coupled with” implies any connection between the two elements coupled with one another, whether indirect or direct. In particular, where two elements are coupled with each other for purposes of providing fluid communication between those elements, the term “coupled with” should be interpreted as connoting any connection that provides the required fluid communication, regardless of the means of coupling the elements with one another.) As described in detail below, the fluid container(s) 130 can be configured to allow dispensation of the fluid directly from the container 130, allowing the user to forego bulk storage of the fluid and eliminating the need to install or otherwise use additional dispensing equipment. The fluid container(s) 130 also can, in some embodiments, be configured to be easily transportable by a general purpose transportation vehicle, such as a utility truck. In this way, for instance, a fluid supplier may deliver (or contract to have delivered) to the user any necessary fluids in a container 130 already configured to dispense the fluid, providing enhanced efficiency to both the user and the fluid supplier.

In addition, as described in detail below, the modular format of the fluid containers 130 can allow for accounting of the fluid on an as-used basis, if desired. Many previous fluid distribution methods, whereby fluids are delivered in bulk to a tank at the user location, fail to allow for this flexibility in accounting. Thus, the containers 130 featured in some embodiments of the invention can allow a fluid user to eliminate the need for an inventory of fluids, thereby reducing costs for the user. As another advantage over other fluid distribution systems, the containers 130 may be reusable, reducing both waste products and costs for both the fluid supplier and the user. Merely by way of example, when a new fluid container is delivered, an empty container may be placed on the delivery vehicle for return to the fluid supplier, where it may be refilled for future use.

Moreover, the fluid containers 130 may be used for other purposes as well. Merely by way of example, an otherwise empty fluid container may be charged with a pressurized gas (by the user and/or the fluid supplier) and thereafter used to dispense the gas and/or provide a source of pressurized gas for dispensation of other fluids. In addition, the containers 130 may (but need not be) configured to allow the user to fill the container with a fluid of the user's choice, allowing the containers 130 to be used for many purposes.

The fluid containers 130 may be provided in any appropriate size. Generally, the containers 130 will range in volume from about one pint to about one hundred gallons in capacity, and more particularly, from about twenty gallons to about fifty gallons in capacity, although containers of other sizes certainly may be used in accordance with various embodiments of the invention. In a certain set of embodiments, the containers 130 are standardized to hold between about two quarts and about fifty gallons of fluid, and more particularly between about one gallon and about twenty gallons of fluid. Often, the containers 130 are generally cylindrical in shape, although other configurations may be used as well.

The fluid containers 130 may be configured to dispense fluid without assistance from any other equipment. Alternatively, a fluid distribution station 120 may be used to facilitate the distribution of fluids. The fluid distribution station 120, as described in detail below, can include facilities for measuring the fluid as it is dispensed, controlling the dispensation of fluid (e.g., for security and/or safety purposes), and/or communication data about the fluid and/or its dispensation to the control terminal 115. In an alternative embodiment, the functionality ascribed herein to the fluid distribution station 120 may be incorporated within one or more of the fluid containers 130.

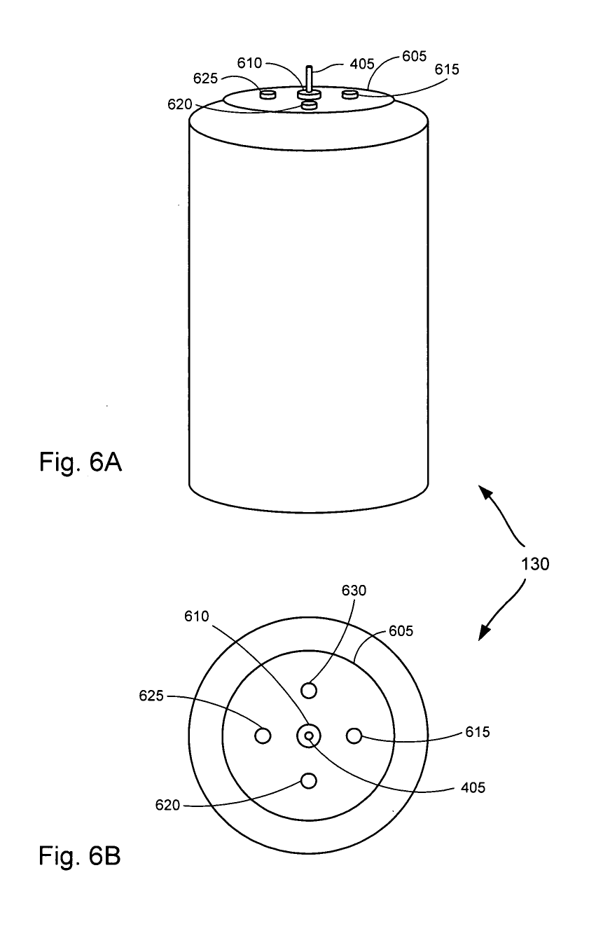

The control terminal 115, therefore, can be used to authorize dispensation of fluid from the fluid distribution station 125 and/or the fluid container(s) 130. The authorization may be in response to a request from the fluid distribution station, as described in more detail below. The control terminal 115 may also be used to calculate and/or make a record (locally and/or at the server 110) of the amount and/or nature of the fluid dispensed, the amount of fluid remaining in a fluid container 130, and/or any other information relating to the dispensing of fluid using the station 120. As described above, the control terminal 115 may also be in communication with one or more servers (e.g., 110), and the control terminal may be configured to transmit information to and/or receive information from the server(s) 110. Detailed examples of such transmissions are discussed below with respect to FIG. 6. In some embodiments, a plurality of control terminals 115, distribution stations 120 (and/or fluid containers 130), and/or servers 110 may be in communication. Thus, for example, a single control terminal could communicate with several distribution stations at a user facility and/or a single server could communicate with several control terminals at one or more user facilities. Alternatively, a user facility could employ a network of control terminals, each communicating with one or more distribution stations. In further embodiments, a distribution station could incorporate the functionality of a control terminal and/or could communicate directly with a server.

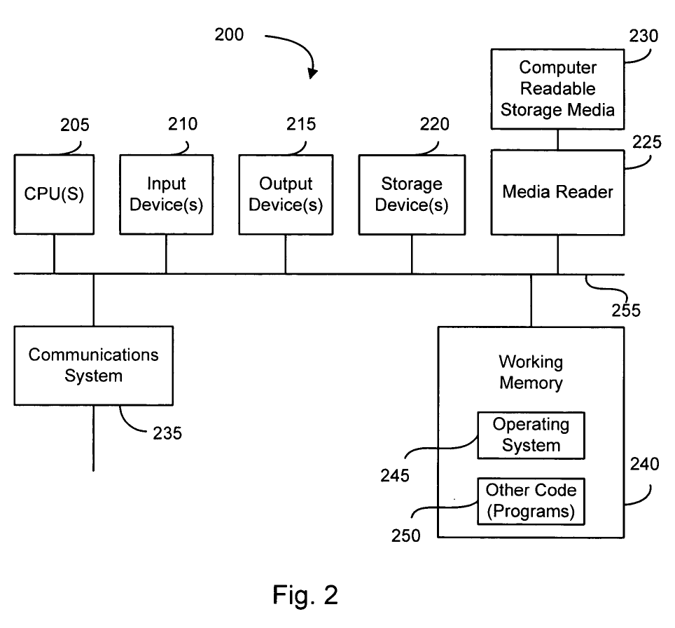

In some embodiments, a control terminal can comprise specialized hardware adapted to communicate with a fluid distribution station 120 and/or a server 110. In fact, the control terminal can serve merely as a communication intermediary between these components. In other embodiments, however, the control terminal can comprise one or more general purpose personal computers (e.g., 115) (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially-available UNIX™ or UNIX-like operating systems. The control terminal 115 may incorporate one or more of the components described with respect to FIG. 2, infra.

The system 100 may also include one or more additional client devices, which, depending on their capabilities, can operate to receive information about the system (e.g., fluid levels, fluids dispensed, accounting information, system status information, etc.) and/or to transmit information (e.g., requests for authorization to dispense a fluid, orders for more fluid, status inquiries, etc.) to the server 110, control terminal 115 and/or fluid distribution system 120 These client devices, which can be located at the supplier location, user location and/or elsewhere, and which can be operated by the supplier, user and/or a third party) can comprise any electronic device capable of communicating with the system 100 (using voice communications, data communications, and/or the like). Exemplary devices include, but are not limited to, personal computers, thin-client computers, POTS telephones and/or wireless telephones (e.g., 145), Internet-enabled mobile telephones, handheld computers and/or personal digital assistant (e.g., 135), pagers (e.g., 140). These client devices, again depending on their capabilities, can also have any of a variety of applications, including one or more database client and/or server applications, and/or web browser applications. Although the exemplary system 100 is shown with three client devices, any number of each of the illustrated client devices can be supported, and those skilled in the art will appreciate that the illustrated devices, while exemplary, are not exhaustive of the types of client devices that could be supported by embodiments of the invention.

FIG. 2 provides a generalized schematic illustration of a processing device 200 that may be used in accordance with the embodiments of the invention, including, for instance, the exemplary system 100 described above. Merely by way of example, one or more of the components described as part of the processing device 200 may be incorporated into the server 110, control terminal 115, fluid distribution station 120 and/or other client devices supported by various embodiments of the invention.

FIG. 2 provides a schematic illustration of one embodiment of a system 200 that can perform the methods of the invention and/or the functions of a client device, server computer and/or communication processing system, as described herein. This figure broadly illustrates how individual system elements may be implemented in a relatively separated or relatively more integrated manner. The device 200 is shown comprising hardware elements that can be coupled electrically via a bus 255, including a processor 205; an input device 210, which can include without limitation a mouse, a keyboard, a numeric keypad, a tablet and/or the like; an output device 215, which can include without limitation a speaker, a display device, a printer and/or the like; a storage device 220, which can include without limitation a disk drive, an optical storage device, solid-state storage device such as a random access memory (“RAM”) and/or a read-only memory (“ROM”), which can be programmable, flash-updateable and/or the like; and a computer-readable storage media reader 225. The computer-readable storage media reader 225 can further be connected to a computer-readable storage medium 230, together (and, optionally, in combination with storage device(s) 220) comprehensively representing remote, local, fixed, and/or removable storage devices plus storage media for temporarily and/or more permanently containing computer-readable information. Such storage media (sometimes in conjunction with one or more processors, memory devices, instructions and/or the like) can serve as a means to perform many of the storage functions described elsewhere herein.

The processing device 200 can further comprise a communications system 235; which can include without limitation a modem, a network card (wireless or wired), an infra-red communication device, an RF and/or wireless transceiver and/or antenna, and/or the like. The communications system 235 may permit data to be exchanged with the network 105 and/or any other computer/device described above with respect to the system 100. The processing device 200 can also include a memory 240, which can include a RAM or ROM device, as described above.

The computer system 200 also can incorporate software and/or firmware instructions, which can be executed by one or more of the hardware components to accomplish specific functions in accordance with embodiments of the invention. In this way, for instance, a processor (e.g., the illustrated processor 205, perhaps in conjunction with the illustrated processing acceleration unit 235), when executing such instructions, can serve as a means to perform many of the functions described elsewhere herein. These instructions can include operating systems and application programs, as described in detail above and/or as known in the art. Such instructions are illustrated in FIG. 2 as located within a working memory 240, including an operating system 245 and other code 250 (e.g., an application program), which are described above and/or designed to implement methods of the invention. It will be apparent to those skilled in the art that substantial variations may be made in accordance with specific requirements. For example, customized hardware might also be used and/or particular elements might be implemented in hardware, software (including portable software, such as applets), or both. Further, connection to other computing devices such as network input/output devices may be employed.

FIG. 3A provides a detailed perspective drawing illustrating a fluid distribution station 120 in accordance with various embodiments of the invention. The station 120 generally comprises a body 305 capable of supporting one or more fluid containers (which may include fluid containers 130 described above). The body 305 can be constructed of any suitable material, including without limitation, steel, aluminum, titanium, plastic (including suitable thermoplastics), and/or the like. The body 305 can include one or more means for facilitating the dispensation of fluid from the containers 130, including, merely by way of example, one or more hose reels 310. Any of several varieties of commercially-available hose reels may be used, including, for instance, those hose reels available from Cox Reels, of Tempe, Ariz., USA. Other means for facilitating the dispensation of fluid may be used as well, including simple hoses (which can be constructed of any suitable material, including rubber, nylon, and the like). In some cases, it may be preferable for the hoses to be resistant to corrosion from the types of fluids likely to be dispensed by the cart 120. In other embodiments, other devices may be used to facilitate dispensation of fluid, including taps, spigots and the like. Such devices may rely exclusively on gravity for their operation, or they may be assisted by one or more pumps, pressurized gas, etc.

In some embodiments, such devices for dispensing the fluid may be connected to and/or incorporated in the fluid containers 130, and/or the devices may be mounted on, incorporated in and/or attached to the fluid distribution system 120 itself. Merely by way of example, the hose reels 310 in the example illustrated here are coupled to a mounting frame 315, which may be attached to and/or incorporated with the cart body 305. Each of the dispensing devices may include any necessary additional apparatus (not illustrated in FIG. 3A but described in detail below) to facilitate dispensing, including without limitation, handles (which can incorporate triggering devices to control the flow of dispensed fluid), check valves (e.g., to prevent backflow of the fluid), metering devices, and the like.

In some embodiments, the mounting frame 315 may be removably attached to the body 305 (e.g., with bolts and/or other similar fasteners, tongue-and-groove fittings and/or the like), allowing the frame 315 and/or the hose reels 310 to be easily removed and/or replaced. In other embodiments, the frame 315 may be attached relatively permanently (e.g., welded, etc.) to and/or formed together with the body 305. In such embodiments, the dispensing devices (e.g., hose reels 310) may be relatively removably attached to the frame 315. In some cases, each of a plurality of dispensing devices may be in contact with each of a plurality of containers, for instance to prevent cross-contamination of different fluids being dispensed and/or to allow the dispensation of multiple fluids simultaneously. Merely by way of example, the fluid distribution station 120 of FIG. 3A includes a plurality of connection hoses 320, each of which can provide fluid communication between a container 130 (and/or another fluid source, such as a source of pressurized gas) and a hose reel 315. In other cases, a single dispensing device may be in fluid communication with a plurality of containers (or vice-versa) using manifold and/or other fluid routing systems familiar to those skilled in the art.

In accordance with certain embodiments, the fluid distribution station 120 may include one or more means for providing pressure to the station 120 and/or the fluid containers 130. Merely by way of example, the station 120 can include one or more gas input hose reels 325, which can be configured to accept a supply of pressurized gas, such as air, oxygen, nitrogen and/or the like. (In some cases, it may be desirable that the pressurized gas comprises an inert substance, such as argon, etc., to prevent reaction with the fluid being dispensed.) Alternatively (or in addition), one or more of the fluid containers 130 may be filled with a pressurized gas (from a hose reel 320 and/or another source) and used as a source of pressurized gas, allowing the fluid distribution station 120 to be used without a connection to a separate source of pressurized gas. In other embodiments, other pressurizing methods may be used; for example, a pump (which can either be a liquid pump and/or a gas pump) may be integrated with and/or attached to the station 120 and/or one or more containers to provide direct pressure on the fluids being dispensed and/or to provide an independent source of pneumatic pressure for the fluid containers 130. Merely by way of example, the station 120 and/or any of the containers 130 could include (and/or be in fluid communication with) a manual pump, an electric and/or combustion-driven pump, and/or the like.

As noted above, in accordance with many embodiments, a fluid distribution station and/or a fluid container may include control electronics, which can include one or more processors and/or any of the other components described with respect to FIG. 2, to facilitate, monitor and/or control the dispensing of fluid from the station and/or container. Merely by way of example, the fluid dispensing station 120 of FIG. 3A features a housing 330 which can be (but need not be) accessible to the user of the station 120 via a hatch, door, etc. (not shown on FIG. 3A). The housing 330 can enclose such control electronics (not illustrated in FIG. 3A but described in detail with respect to FIG. 3B, infra, and referred to generally as a “processor” in this discussion), which can include one or more specialized processors (e.g., a processor embedded incorporating and/or coupled with a memory having instructions to control the processor) and/or a general-purpose computer having specialized software. In either case, the processor can have instructions for operating various functions of the fluid distribution station 120 and/or fluid container(s) 130.

The processor may have an input interface, such as a keyboard, touch pad, joystick, trackball, etc. to allow a user to input data, control station 120 and/or fluid container 130 functions, request authorization to dispense, etc. The processor may also have an output interface, such as a screen (which can be a CRT, an LCD and/or the like) a LED/LCD readout, indicator light(s), and the like, to convey to a user information about functioning of the station 120 and/or fluid containers 130. Merely by way of example, the illustrated fluid distribution station 120 includes a keypad 335 and a display screen 340 as input and output interfaces, respectively, to the processor. The location of the input and/or output interfaces are discretionary. For example, in the illustrated station 120, the keypad 335 and display screen 340 are affixed to (and/or incorporated in) the housing 330. In other embodiments, the input and/or output devices may be located elsewhere, such as attached to the frame 315, to allow for easier viewing and/or input of data. In still other embodiments, there may be a plurality of input and/or output interfaces on the station 120, to allow for expeditious data input and/or review from a variety of positions respective to the station.

As described in more detail below, the processor can provide communication and/or control with various of the systems implemented by the distribution station 120, in accordance with certain embodiments of the invention. In addition, the processor may include (or be in communication with) one or more data communication interfaces, which can serve as a means for communicating with a control terminal and/or a server. Some exemplary communication devices are described above. Thus, for instance, the station 120 may include a wireless transmitter, receiver and/or antenna 345, which can communicate by wireless and/or RF communication with a control terminal and/or server similarly equipped. Alternatively (and/or in addition), the station 120 may comprise a wired communication interface (e.g., an Ethernet port, a serial port, etc.) to support a wired connection.

As noted above, in some embodiments, the fluid distribution station may be mobile. Thus, the station 120 may be mounted on one or more mobility devices, which can include, inter alia, casters, wheels, tires, treads, and the like, and which may be of uniform or different sizes. Those skilled in the art will appreciate that different types of mobility devices can be used to accommodate different operating environments and/or surfaces. In some cases, the mobility devices can be adapted to correspond to tracks, rails, etc., allowing the station 120 to move only along specified paths. In other cases, the mobility devices can allow for relatively free movement of the station 120, allowing the station 120 to be maneuvered into any desired position. Merely by way of example, the station 120 illustrated in FIG. 3A includes a plurality of wheels 350, which can allow the station relatively free mobility along any relatively smooth surface. If desired, the fluid distribution station 120 may have one or more controls (e.g., a tiller 365, which is commonly available and known in the art, a steering wheel, a joystick, a keypad, a touchscreen, a mouse, a trackball, etc.) and/or handles to allow for the manipulation of the station 120. The controls (e.g., the tiller 365) may be coupled, electronically and/or mechanically (e.g., via linkages known in the art) to one or more of the mobility devices, which may be steerable, allowing the tiller 365 to be used as a steering apparatus. Optionally, the tiller 365 and/or other means, such as friction brakes, etc., can be used to lock the mobility devices, preventing undesired movement of the station 120.

In addition, the distribution station 120 may be capable of powered movement, to mitigate and/or eliminate any physical effort from a user in moving the station 120. Thus, the station 120 may include one or more means for locomotion (also referred to herein as “locomotive means”), which can comprise, inter alia, one or more electric motors, combustion-driven motors, and/or the like, along with, in some cases, any necessary control apparatus, including without limitation those discussed above. Merely by way of example, the illustrated station 120 includes an electric motor 355 (illustrated as enclosed within a housing), which is in communication with one or more of the wheels 350, using a standard drive train known in the art. The choice of motors is discretionary. In some embodiments, the motor(s) collectively can produce sufficient power to move the station 120 at the desired velocity. Those skilled in the art will appreciate that there are many commercially-available powered cards and/or cart-powering systems, including without limitation the systems available from the Hilgendorf Cart Division of CSF, Inc., Stouton, Wis., USA and/or the systems described in U.S. Pat. No. 5,522,471 issued Jun. 4, 1996 to Hilgendorf and/or U.S. Pat. No. 3,308,974 issued Mar. 14, 1967 to Rosenbaum, of which the entire disclosures of each are incorporated herein by reference for all purposes. One skilled in the art will appreciate, based on the disclosure herein, that such powered carts and/or powering systems may be modified as appropriate and used to perform certain functions of a distribution station in accordance with various embodiments of the invention.

In some embodiments, the tiller 365 (and/or other controls) can be in communication with the locomotive means (directly and/or via control electronics, as described below), allowing the use of the tiller 365 to regulate both the direction and the speed of the station 120. Merely by way of example, in particular embodiments, the station 120 comprises three wheels, two disposed near one end and toward either side of the station 120, with the third wheel disposed centrally and toward the other end. The third wheel may be steerable, and the tiller 365 may be in communication with the third wheel, to provide steering control to the user. The third will may also be coupled (via a linkage and/or a direct-axle drive) to the locomotive means, such that the locomotive means drives the third wheel, with the tiller providing both velocity control (via the locomotive means and/or a brake) and steering control (via the positioning of the third wheel).

The fluid distribution station 120 may also provide a fuel source for the locomotive means and/or the control electronics. If the locomotive means comprises an electric motor, a suitable fuel source can be one or more batteries (e.g., battery 360) having a suitable output current. In such cases, the battery 360 can also be used to power the control electronics (and/or any other components incorporated in and/or attached to the station 120 and/or fluid tanks 130 requiring electric power), and/or one or more additional batteries can be provided for this purpose. If the locomotive means comprises a combustion engine, the fuel source for the engine can be a tank containing the appropriate fuel for the engine, and the engine may drive a generator and/or alternator for providing electric power to the control electronics and/or other devices. Alternatively, a separate generator and/or batteries may be provided for this purpose.

In accordance with some embodiments, the station 120 can include wiring to provide electrical communication between the processor and various other components. FIG. 3B provides a schematic diagram illustrating a processor 370 coupled to several such components, in accordance with certain embodiments of the invention. As illustrated in FIG. 3B, the processor 370 can be in communication with one or more flow metering and/or control devices 375 (discussed in detail infra), which themselves can be in fluid communication with the station 120, fluid containers 130, and or any attached fluid distribution devices, such as hose reels. In a particular embodiment, a separate flow meter and/or flow control device can measure and/or regulate the flow of fluid out of each container. In this way, the processor 370 can control and/or receive data regarding the flow of fluid through such devices. The processor 370 may also be in communication with one or more pressure regulators and/or gauges (also described in detail, infra), allowing the processor to control and/or receive data regarding the gas pressure transmitted to (and/or within) the fluid containers 130. In some cases, a single regulator/gauge may be used to measure/regulate pressure (e.g., the regulator/gauge can be attached to a main supply line from a pressure source, while in other cases, each container 130 (or supply line thereto) may incorporate and/or be in communication with its own regulator/gauge. If a pump 385 is used to facilitate the distribution of fluid, the processor 370 may also be in communication with the pump 385, and therefore the processor can be used to monitor and/or control the operation of the pump.

In order to receive instructions (e.g., for controlling a flow control device, etc.), the processor may be in communication with an input interface, such as the keypad 335 (and/or any other input interface, including those discussed above). Similarly, to allow the user to monitor the operation of various components of the station 120 (and/or the processor's control over those components), the processor can be in communication with an output interface, such as the display 340 illustrated here. To provide data communication between the station 120 and a control terminal and/or server, the processor may be in communication with a communication device, which can include, for instance an wireless transmitter, receiver and/or antenna 345, as well as various other communication devices discussed above.

In accordance with embodiments where the fluid distribution station is configured for powered movement, the processor 370 may be in communication with any locomotive means (including, for instance an electric motor 355) and/or any control device 365 used to operate the locomotive means. In this fashion, the processor may (but need not) assist in the control of the station's motion (for instance, regulating and/or translating input from the control device 365) and/or monitor the motion of the station 120 (e.g., by calculating and/or providing information about the velocity of the station 120). In accordance with other embodiments, however, the control device may be in direct communication with the locomotive means, bypassing the processor.

Similarly, those skilled in the art will appreciate that the functions ascribed to the processor 370 may be divided among a plurality of processors (e.g., one processor relating to dispensing operations, another related to locomotive operations, and yet another covering communication with a control terminal and/or server). Each of the plurality of processors may be (but need not be) in communication one with another. In other embodiments, some of the operations may not utilize a processor.

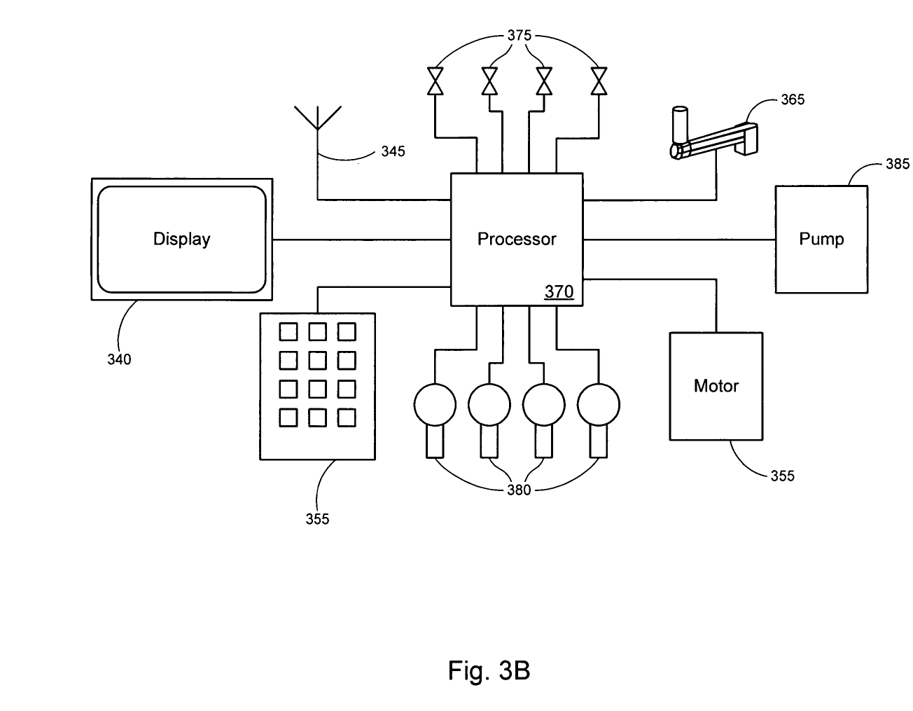

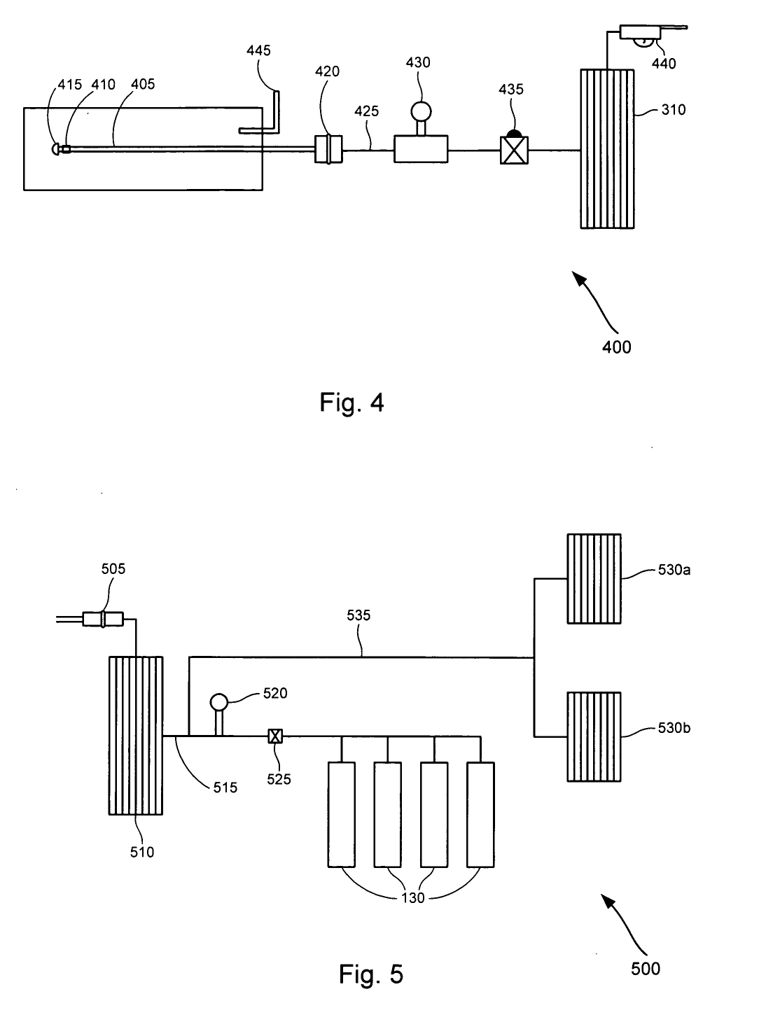

Certain embodiments of the invention may feature an “attachment mechanism” and/or a “connecting mechanism,” which can be any device (or system of devices) that function to provide fluid communication between two components, including for example, a fluid container and a fluid distribution station (in the case of a connecting mechanism) and/or a pressure source and a distribution station/fluid container (in the case of an attachment mechanism). Merely by way of example, a connecting/attachment mechanism can comprise a delivery tube, a quick-connect fitting, a threaded fitting, etc. Thus, one or more of components of a dispensing system and pressure supply system, examples of which are illustrated schematically on FIGS. 4 and 5, respectively, may function as an connecting mechanisms and/or attachment mechanisms.

The exemplary dispensing system 400 of FIG. 4 may be implemented in conjunction with (and/or as a part of) a fluid distribution station and/or fluid container, such as those described above. The exemplary dispensing system 400 includes a fluid container 130, which may comprise a delivery tube 405 incorporating (and/or in fluid communication with) a check valve 410, which can prevent fluid backflow, as will be appreciated by those skilled in the art. Disposed at (or near) one end of the delivery tube 405, there may be a contaminant-prevention device (such as a filter, strainer, etc. commonly used in the art), which can serve to prevent any particulate or other contaminants in the stored fluid from entering the delivery tube 405.

The other end of the delivery tube may extend through one surface of the fluid container 130, where it may terminate in any of several well-known hydraulic valves and/or connectors, including for example, a quick-connect valve 420 (of which the whole and/or a part can serve as a connecting mechanism). The valve 420 can provide fluid communication between the delivery tube 405 and a fluid supply hose 425, which can further be in fluid communication with a fluid dispensing device, such as a hose reel 310. A flow measuring device 430, which can comprise an impulse meter and/or any similar device known in the art, may be incorporated and/or coupled to the supply hose 425 in such a way that the flow measuring device 430 is operable to measure the rate and/or volume of fluid flowing out of the container 130 and/or through the supply hose 425. In addition, the fluid dispensing system 400 may incorporate a flow control device 435, such as a solenoid valve, manual valve, pressure sensitive valve, etc. to regulate or otherwise control the flow of fluid from the container 130. The hose reel 310 (and/or a hose incorporated with the hose reel 310) may be in fluid communication with an additional dispensing device 440, which can facilitate the dispensing of fluid using the system 400. Examples of dispensing devices can include oil control guns, such as those commercially available from, among others, Samoa Industrial, S.A.; Graco, Inc., Minneapolis, Minn., USA; Alemite Corp., Charlotte, N.C., USA; Balcrank Products, Inc., Weaverville, N.C., USA; and Lincoln Industrial Corp., St. Louis, Mo., USA. In some cases, the dispensing device 440 can include additional flow control apparatus, allowing a user to control directly the flow of fluid through the dispensing device 440.

The fluid dispensing system 400 can also include a pressure source 445, the operation of which is described in further detail with respect to FIG. 5 and which can include a supply line for supplying a pressurized gas, a pump, and/or the like. In operation, therefore, the pressure source 445 can apply a pressure to the fluid in the container 130, forcing fluid through the delivery tube 405 into the supply hose 425, where the flow of the fluid can be measured by the flow measuring device 430 and/or controlled by the flow control device 435. If allowed by the flow control device 435, the fluid can flow to the hose reel 310 and/or the dispensing device 440, where it may be dispensed by the user. The fluid container 130 may also be coupled with a gas supply line 445, which can provide a supply of pressurized gas to facilitate the dispensing of fluid from the container 130.

FIG. 5 illustrates an example system 500 for supplying pressurized gas in accordance with embodiments of the invention. The system 500 includes a fitting 505 that may be coupled to a source of compressed gas, and which may function as an attachment mechanism. In some embodiments, the source of the compressed gas may be external to the fluid distribution station (e.g., a commercially available, high-volume compressor installed at the user's facility, etc.), while in other cases, the source of the compressed gas can be incorporated in (and/or attached to) the station itself (e.g., a fluid container having stored therein pressurized gas, a portable pump and/or compressor, etc.). The fitting 505 can be a commercially-available pneumatic quick-connect fitting and/or any other suitable fitting that can provide communication between the system 500 and a source of pressurized gas. The system 500 can further include a source hose reel 510 in communication with the fitting 505, so that the fitting 505 may be extended away from the system (and, by implication, from the station and/or containers with which the system 500 is used), allowing for the use of a fixed source of pressurized gas while still allowing positional freedom and/or mobility for the station/containers. The source hose reel 510 can provide pressurized gas to a distribution line 515, which may incorporate (and/or be coupled to) any known measuring and/or regulating device (collectively depicted as a regulator/gauge 520), which can include, merely by way of example, a gauge (which can be analog and/or digital, and/or which can be in communication with control electronics, as described above), a regulator (which likewise can be in communication with control electronics), a filter, and/or the like. Using such devices, system-wide pressure can be controlled and/or monitored (manually and/or via the control electronics).

The distribution line 515 can comprise any suitable material, including several varieties of commercially-available air hoses, metallic (e.g., copper, steel, etc.) tubing, and/or the like, and can be in communication with one or more fluid containers 130, for instance as described with respect to FIG. 4. Merely by way of example, the distribution line may be coupled with a plurality of T-adaptors, each of which can be coupled (using an extension hose, if needed, and/or any necessary attachment fittings) with one or more fluid containers 130. The distribution line 515 can also include means for interrupting the supply of pressurized gas to the containers, for instance to allow for a quick method of ceasing all fluid distribution options. Merely by way of example, the exemplary system uses a solenoid valve 525, which may be in communication with control electronics. Other means could include a manual valve, a pressure-sensitive valve, and/or the like. The supply line 515 may also provide a supply of pressurized gas to one or more gas distribution hose reels 530 via an auxiliary supply line 535, which may be coupled with the distribution line 515 using any suitable means. The gas distribution hose reels therefore can provide a supply of pressurized gas for any suitable use (such as inflation of tires, cleaning, operation of pneumatic tools, and/or the like), and may include and/or be coupled to any fittings suitable for such uses.

In some embodiments, the layout of the distribution line 515 and the auxiliary line 535 may be arranged to subject to regulation and/or monitoring by the gauge/regulator 420 and/or the solenoid valve 525. In other embodiments (such as that illustrated by FIG. 5), the auxiliary line 525 may be coupled to the distribution line in such a way as to bypass these devices. In further embodiments, the auxiliary line 535 may include similar devices for monitoring, filtering and/or controlling the flow of pressurized gas to the gas distribution hose reels 530.

Taken together, the systems described with respect to FIGS. 4 and 5 (and/or any of the components thereof) can represent one example of a “fluid displacement” mechanism, which, for purposes of this document, should be thought of as any mechanism/system for displacing fluid from a fluid container, allowing the dispensation of that fluid in a desired location. Other examples of fluid displacement mechanisms, described in detail above, can feature pumps, vacuum systems, etc., and/or any necessary hoses, tubing, fittings, etc.

FIGS. 6A and 6B depict the exterior of an exemplary fluid container 130. In accordance with some embodiments of the invention, a top portion 605 of the container 130 may describe several openings, each of which may be used for various purposes, and each of which may include to appropriate valves, fittings and/or the like. In particular, each of the openings may include valves (which may be self-sealing) in order to allow the interior portion of the container 130 to be pressurized to facilitate the dispensation of fluid therefrom. In some embodiments, the openings may be circular (and/or any other suitable shape) andy may vary in size (according to application) from one-eight inch to two inches, and in particular from one-quarter inch to one-half inch. Merely by way of example, the top portion 605 may feature a first opening 610, through which a fluid delivery tube 405 may extend from the exterior of the container 130 into the interior, to allow the transmission of fluid from the container. The opening 610 may be configured to form a tight fit around the delivery tube 405 to prevent the loss of pressure from the container 130. Alternatively, the opening 610 may comprise a fitting (e.g., a hydraulic quick connect, a threaded fitting, etc.) coupled to the delivery tube 425 (which can extend therefrom into the interior of the container 130), such that the delivery tube 425 does not extend to the exterior of the container, and the fitting may further be coupled to a fluid supply hose 425. Thus, the fitting may function as a connecting mechanism in accordance with certain embodiments of the invention.

The top portion 605 may also comprise a second opening 615, which also can be coupled to a gas supply line 445 (e.g., by a pneumatic quick-connect valve, a threaded fitting, etc.), to allow for the pressurization of the container 130. A third opening 620 can feature a fitting to allow the attachment of a gauge, regulator, etc (as described above), to allow for the monitoring and/or control of the pressure inside the container 130. A fourth opening 625 can be configured to have disposed therein a pressure-relief valve commonly known in the art, which can be configured to open at a certain pressure (which may be configurable by the user), to prevent overpressure in the container 130, reducing the risk of equipment failure. A fifth opening 630 can be configured to accept a cap (e.g., by including threading that corresponds to a threaded portion of the cap, etc.), which, when removed, can provide access to the interior of the container 130, to allow inspection, refilling, etc. In accordance with particular embodiments, the fifth opening can be between about one-and-one-half inches and about two-and-one-half inches, which can allow for quick refilling of the container 130.

In various embodiments, the openings on the top portion 605 may be arranged differently, and/or openings may be added and/or omitted. Likewise, the openings (or others) may be positioned on different portions of the container. Those skilled in the art will appreciate that the configuration of the container and/or openings is discretionary, and that the configuration illustrated on FIGS. 6A and 6B is merely exemplary.

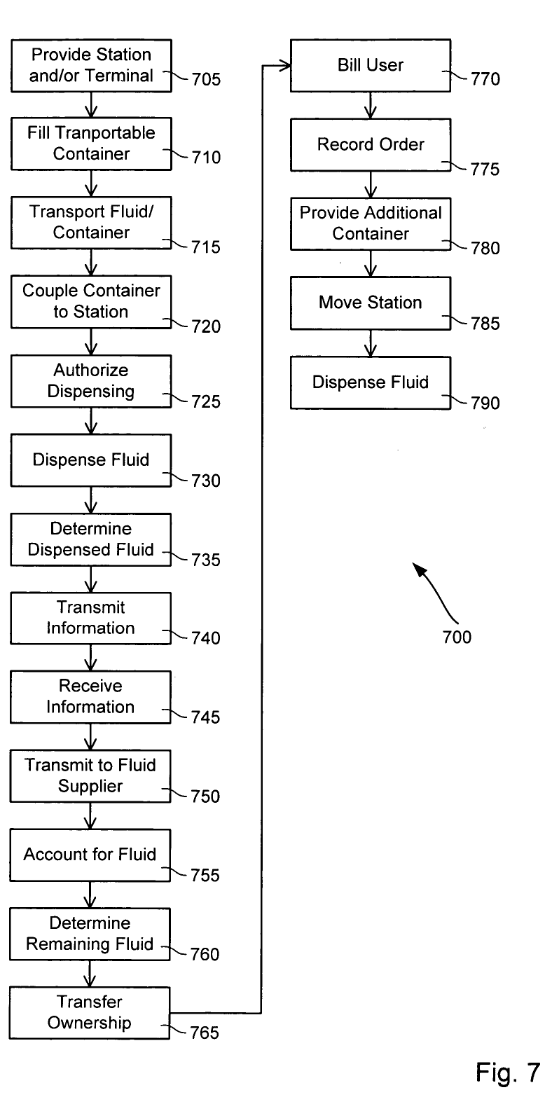

Some embodiments of the invention provide methods of distributing fluids. One exemplary method 700 in accordance with various embodiments is illustrated by FIG. 7. The method can include providing a distribution station and/or control terminal to a user (block 705). In some cases, providing this equipment can comprise selling the equipment to the user. In other cases, a fluid supplier might provide the equipment in other ways, to mitigate the up-front capital outlay required of the user. Merely by way of example, if the user agrees to a relatively long-term contract for purchasing fluids (and/or other goods/services) from the supplier, the supplier could agree to offer favorable financing terms for the equipment, or even provide the equipment for a reduced price (or for free, either permanently or for the duration of the contract term). In addition, the supplier could lease the equipment to the user, again mitigating up-front costs to the user and providing an incentive for the user to contract with that supplier. (Alternatively, if the user may provide a general computer, and providing the control terminal can comprise providing (e.g., selling, licensing, giving) the necessary control software and/or communication equipment to the user for use with the user's computer.).

The method can further comprise filling one or more transportable fluid containers (block 710). Because the containers can be configured to be transportable when full, filling the container usually (but not necessarily) occurs at a factory, refinery, depot, etc., where the fluids are stored in large quantities by the supplier and/or a third party. Alternatively, in some embodiments, the container may be filled at another location, such as at the user's location, either by the user, the fluid supplier and/or by a third party. In this way, embodiments of the invention can allow the user and/or supplier great flexibility in determining how the containers are used and/or filled. (If desired, containers may be configured to be openable for filling only by the supplier, allowing the supplier to control how the containers are used/filled).

The fluid and/or containers (either filled or unfilled) may be transported to the user's location (block 715). Advantageously, because the containers can be modular and/or transportable, transportation of the fluid in containers may be accomplished by any general purpose vehicle (such as a dry-goods delivery vehicle), obviating the need for the traditional tank truck for the delivery of the fluids. Thus, if desired, transporting the containers can comprise contracting with a third party (such as a delivery services, freight shipper, etc.) to transport the containers to the user's location. In any case, transport of the fluid (within the containers) is likely to be significantly more efficient and/or less expensive than delivery by traditional methods. In some cases, however, the supplier and/or user may choose to have fluids transported more traditionally (e.g., in a tank truck), and the containers may be filled from that truck (and/or a larger storage tank) located at the user's facility.

Notably, however, in accordance with certain embodiments, transport of a fluid and/or container to the user need not include transferring ownership of the fluid from the supplier (and/or a third party) to the user. As explained in more detail below, the supplier (and/or a third party) may retain ownership of the fluid until some of the fluid is dispensed from the container, at which point the dispensed fluid may be accounted for, while the fluid remaining in the container can remain the property of the supplier and/or the third party. (Of course, in alternative embodiments, ownership of the fluid may be transferred upon delivery, in the traditional fashion).

One or more containers may then be coupled to a fluid distribution station (block 720). The containers may be filled or empty, and coupling a container to the fluid distribution system can comprise placing the container on, in or near the station, and/or providing fluid communication between the container and the station. Additionally, coupling a container to a station can comprise coupling the container to a source of pressurized gas (as described above), to provide a fluid displacement mechanism for the fluid in the container. Coupling the container to the station can further comprise inputting (via an input interface at the station, via a control terminal, and/or via a server) data about the container and/or the fluid contained therein. Such data can include instructions about whether authorization is required to dispense the fluid, the volume of fluid in the container when first coupled to the station, the nature of the fluid in the container, and/or the like.

In some cases, each container might have an associated identifier, which can serve to identify the container and/or the fluid it contains. Such an identifier can be displayed on the container, printed on a manifest, included in a bar code on the container and/or manifest (such that the user and/or supplier can use commonly-available bar code scanners to input information about the container), stored in an Radio Frequency Identification (RFID) chip (such that a receiver in communication with the distribution station, control terminal and/or server can receive information about the container electronically, and/or the like). In some cases, the identifier (or a portion thereof) might be a code that indicates the type and/or quantity of fluid in the container when delivered, such that the identifier (or portion thereof) is common to each container having that type of fluid and/or is modifiable depending on the type and/or amount of fluid currently stored in the container. In other cases, the identifier (or a portion thereof) might be an identifier that uniquely identifies the container, such that the identifier can be used to determine the type and/or amount of fluid in the container when transported (e.g., by querying the supplier's server using the identifier as a key). Such identifiers can provide for efficient inventory control for both the supplier and/or the user. Alternatively, data about the container and/or fluid in the container may be input manually by the supplier and/or user into the server, control terminal and/or distribution station.

In some embodiments, the distribution station/fluid container can include a menu-driven system for selecting fluids to be dispensed. If desired, information about available fluids may be transmitted to and/or stored at the distribution station, and/or the user may be presented with a menu of fluids available for dispensing. The menu can be updated automatically and/or manually as needed, and the menu can, if desired, display the currently-available amount of each fluid. Optionally, a certain amount of one or more fluids may be reserved (for instance, for a future, high-priority project and/or to prevent the complete consumption of fluids before additional fluids can be ordered), so that the menu indicates that less fluid is available than is actually present. If the user has sufficient authority, this reservation may be overridden.

In cases in which authorization is required before fluid may be dispensed from the container, the method can comprise authorizing the dispensation of fluid (block 625). In some cases, the distribution station may request authorization. For example, a user may input (e.g., using an input interface) at the station a request to dispense a given volume from a certain container coupled with the station. Alternatively, the user may simply attempt to dispense from a given container. In either case, the station may respond to the user's actions by sending an authorization request to a control terminal and/or server and/or waiting to dispense fluid until an authorization has been received from the control terminal and/or server. In other cases, a control terminal and/or server may authorize dispensation without a request from a station. For instance, a user (and/or the fluid supplier) may input a command at the control terminal (and/or server) to authorize a fluid distribution station to dispense a particular fluid without requiring a request for authorization from the station. In some cases, a user may be required to “log in” to the fluid distribution station/fluid container by entering an identifier and/or password before the dispensing of any fluid is allowed. This login information can be verified by the station, control terminal, server, etc. as desired. (In some cases, the process of logging in can automatically activate procedures preliminary to dispensing activities, such as pressurization of fluid containers, etc.)

In either case, the authorization may be a general authorization (e.g., authorizing the station to dispense any amount of fluid up to the amount remaining in a given container and/or authorizing the station to dispense from any container coupled to the station) or a more limited authorization (authorizing the station to dispense only a specified amount of fluid and/or to dispense from only a specified container). For instance, a general authorization scheme may be implemented for security purposes, such that a user must “log in” by inputting a security code at the station, at which point the station will be generally authorized to dispense fluid (either for a specified period of time, until a specified period of inactivity has lapsed, until the user has logged out, etc.). Alternatively and/or in addition, a limited authorization scheme may be implemented (e.g., with respect to relatively expensive fluids, etc.), whereby each time a user wants to dispense an amount of a certain fluid, the user must input the type and/or amount of fluid desired, and the control terminal and/or server then can authorize the dispensation of only the requested type/amount of fluid. (It should be noted that, in some embodiments, limited and/or general authorization schemes may be implemented by the distribution station, without requiring any communication with a control terminal and/or a server.) In some cases, the system can verify that the desired amount of fluid is present in the fluid container(s) before authorizing dispensation of those fluids and/or can display for the user a message (e.g., at the distribution station and/or control terminal) that sufficient fluid is/is not present. If insufficient fluid is present, the user may be logged out of the station automatically and/or the station may be shut down

At this point, fluid may be dispensed from the station and/or a fluid container (block 730). Dispensing the fluid can comprise operating the station/container as described above to allow fluid to be dispensed as desired. In some cases, the type, amount and/or rate of fluid dispensed can be controlled manually (e.g., by operating a fluid dispensing gun until the desired amount of fluid has been dispensed). In other cases, these values may be controlled by the control electronics, in conjunction with flow metering and/or control devices, either before and/or during dispensing Thus, the user may enter, using an input interface, the desired amount, type, flow rate, etc. of the fluid to be dispensed, and the station may control the dispensing electronically, such that the user need only to position the output hose (or other dispensing device) in the proper position and instruct the station to begin dispensing the fluid. (One skilled in the art will note from the disclosure herein that this process can be combined with the authorization process, if desired). Alternatively, the fluid may be dispensed until the user indicates (perhaps via the control electronics) that dispensing should cease. In addition, the user may enter an identifier associated with the fluid being dispensed (e.g., a project code, customer identifier, etc.), which can facilitate the user's accounting for and/or billing of the fluid used. Optionally, there may be a facility on a distribution station/fluid container to allow for relatively immediate cessation of dispensing activities, allowing for an emergency stop, etc. This facility can include closing a valve on a supply pressure line, a fluid distribution line, etc.

As the fluid is being dispensed (and/or thereafter), the amount of fluid dispensed may be determined (block 735), by direct measurement, calculation, etc. Merely by way of example, as discussed above, a station and/or container may include an impulse flow meter that functions to measure the fluid as it is dispensed. Alternatively and/or in addition, the station may comprise means for weighing the container before and/or after dispensing (e.g., a scale upon which the container sits, etc.), and the amount dispensed can be calculated (by mass, and/or if the specific gravity of the fluid is known, by volume). In some cases, the distribution station may include software (and/or hardware, firmware, etc.) that can track/display for the user a list of dispensing activity, which can include such information as the amount of each fluid dispensed, an associated identifier (project code, etc.) for each amount of fluid dispensed, the name (or other identifier) of the user dispensing each amount of fluid, etc.

Information then may be transmitted by the station and/or container (block 740). The information may transmitted to the control station and/or the server, and the information can include, inter alia, data about the type and/or quantity of fluid dispensed from and/or remaining in a container, information about the date and/or time of dispensing, any identifier associated with the dispensed fluid, and/or the like. Transmitting the information may comprise any suitable transmission method, including without limitation those discussed above.

The transmitted information may be received by a control station (block 745) and/or transmitted by the control station to the fluid supplier (and/or a server operated by the fluid supplier (block 750). In some cases, the information transmitted by the station/container may simply be forwarded by the control terminal to the supplier. (Alternatively, as noted above, the station/container may be configured to transmit information directly to the supplier.) In other cases, information may be stored, modified and/or consolidated before transmission to the supplier. Merely by way of example, information received by the control terminal but not germane to the suppler (e.g., project/client information, time/date of dispensing, information about fluids not supplied by that supplier) may not need to be transmitted to the supplier. As another example, the control terminal may be configured to transmit information to the supplier only periodically and/or when supplies are low (as discussed below).

Optionally, the fluid dispensed may be accounted for (block 755). In some cases, accounting for the fluid dispensed can take place at the control terminal, the supplier (e.g., the supplier's server), the fluid distribution station/fluid container, and/or some combination thereof. In many cases, the software (and/or firmware) on one or more of these system components may include instructions for accounting automatically (and/or with human intervention) for the fluid dispensed. Accounting for the fluid dispensed can include many functions. Merely by way of example, accounting for the fluid dispensed can comprise determining the fluid remaining in a container from which fluid was dispensed (block 760). For instance, if the amount of fluid in the container prior to dispensation is known, the determined amount dispensed can be subtracted from this known value to determine the amount of fluid remaining. Alternatively, the amount remaining may be determined by weighing a container after dispensation is finished.

Accounting for the fluid dispensed can further include transferring ownership of the fluid dispensed (block 765). As noted above, one of the benefits of certain embodiments of the invention is that fluid may be delivered to the user without requiring ownership of the fluid to be transferred until the fluid actually is dispensed. Thus, once a quantity of fluid has been dispensed, ownership of that quantity can be transferred to the user (and/or to a customer of the user, in cases for instance, in which the fluid is provided to a customer of the user, such as in automotive applications). Transferring ownership can (but need not) involve communication between the user (e.g., the station, control terminal, etc.) and the supplier (e.g., the server) at—or shortly after—the time of the transfer. Alternatively, the transfer can be recorded in one location (e.g., at the station, control terminal, etc.), and a reconciliation transaction can be performed periodically (e.g., monthly, etc.) and/or at the time all of the fluid in the container has been dispensed.

In conjunction with (or in lieu of) the transfer of ownership, accounting for the fluid dispensed can comprise billing the user for the fluid dispensed (block 770). In some cases, billing the user can comprise invoicing the user electronically and/or on paper. In other cases, billing the user can comprise an electronic transaction (which can be automatic), such as a credit card charge, electronic funds transfer, etc. Thus, in particular embodiments, once a quantity of fluid has been dispensed, ownership of the fluid can be transferred (e.g., in the accounting records of the supplier and/or user), and funds may be transferred from a bank account of the user to a bank account of the supplier, all in a relatively short period of time (e.g., within a day) if desired, and all without human interaction, if desired. Thus, embodiments of the invention can provide for efficient and/or automated accounting of fluid dispensed, reducing both transaction costs and funds “float” by the user and/or the supplier.

Accounting for the fluid dispensed can further include recording an order for additional fluid (e.g., one or more additional containers of fluid). As described above, in accordance with certain embodiments of the invention, the amount of fluid remaining in a given container can be determined. In cases, therefore, where the distribution of fluid from a container leaves remaining in the container a quantity of fluid falling below a certain threshold (e.g., twenty-five percent of the original amount of fluid in the container, etc.), embodiments of the invention can be configured to record an order for additional fluid of that type, either automatically or via human interaction. Once an additional order has been recorded, additional containers may be provided by the supplier (block 780), for instance in the manner discussed above.

Merely by way of example, if a user takes delivery of a container having contained therein twenty-five gallons of motor oil and subsequently dispenses twenty gallons of that oil (in one or more dispensing activities), the distribution station used to dispense the oil can measure the oil being dispensed and transfer that information to a control terminal. When the container was delivered, the control terminal may have been was updated (as discussed above) to reflect that the container contained the twenty-five gallons of oil. Thus, when oil is dispensed, the distribution station can transmit to the control terminal the amount of oil dispensed (and/or the container from which it was dispensed), and the control terminal (and/or the station) can determine the amount of oil remaining. At the point that it is determined that less than 5 gallons remain, the control terminal can automatically place an order for additional container(s) from the supplier (e.g., by transmitting the order to the supplier's server). Upon receiving the order, the supplier can arrange for the transport of the ordered container(s) to the user. Those skilled in the art will recognize, additionally, that this process can be adapted to cover situations in which multiple containers of a given fluid are used, such that an order is placed when the user has only a threshold quantity of fluid (and/or containers) remaining overall.

Some embodiments of the invention can be used to determine whether a machine, which uses fluids dispensed by a distribution station and/or fluid container, is operating properly, for instance by comparing the amount of fluid dispensed to that machine with an anticipated amount of fluid. (This process can be thought of as another way of accounting for the fluid dispensed). Merely by way of example, if a particular machine normally uses one quart of lubricant (or any other fluid) over a particular period, software running on a distribution station, fluid container, control terminal and/or server can be configured to track the amount of lubricant (or other fluid) dispensed to that machine over time. For instance, before and/or after dispensing fluid in service of the machine, a distribution station can be configured to allow a user to enter an identifier, project code, etc. associated with the machine to be serviced, and the type/amount of fluid dispensed in relation to that identifier can be recorded and/or tracked. The software can also be configured with a nominal amount of fluid that the machine should receive, such that, if more fluid is dispensed (in a single dispensation and/of in multiple dispensations over time) than the machine should need based on its nominal usage characteristics, the software can notify the user, supplier, etc. that the machine is using more fluid than it should need, which can indicate a machine malfunction, fluid leakage, etc.

As noted above, in some embodiments, a fluid distribution station can be mobile. Therefore, the method 700 can include moving the fluid distribution station (block 785), under either external power (e.g., by pushing the station, towing the station, etc.), and/or by using the station's own capacity for powered movement. Once the station has been positioned in its new location, fluid may be dispensed (block 690) in the manner indicated above.

As described herein, various embodiments of the invention provide inventive methods and systems for distributing industrial fluids. The description above identifies certain exemplary embodiments for implementing the invention, but those skilled in the art will recognize that many modifications and variations are possible within the scope of the invention. Merely by way of example, although the described embodiments relate to the distribution of industrial fluids, the methods and systems of the invention could be used to facilitate the distribution of virtually any type of fluid. The invention, therefore, is defined only by the claims set forth below.

1. In a relationship between a fluid supplier and a user, system for distributing fluids, the system comprising:
a transportable fluid container containing a fluid;
a fluid distribution station in fluid communication with the fluid container, the fluid distribution station being configured to:
dispense an amount of fluid from the transportable fluid container;
determine the amount of fluid being dispensed from the transportable fluid container; and
transmit information about the dispensed fluid; and
a computer system in communication with the fluid distribution station, the computer system comprising a processor and instructions executable by the processor to:
receive the information about the dispensed fluid; and
account for the dispensed fluid.

2. A system for distributing fluids as recited in claim 1, wherein determining the amount of fluid being dispensed from the transportable fluid container comprises measuring the amount of fluid being dispensed from the transportable fluid container.

3. A system for distributing fluids as recited in claim 1, wherein the computer system is incorporated within the fluid distribution station.

4. A system for distributing fluids as recited in claim 1, wherein the computer system is incorporated within a control terminal remote from the fluid distribution station.

5. A system for distributing fluids as recited in claim 1, wherein the fluid is a petroleum-based fluid.

6. A system for distributing fluids as recited in claim 1, wherein accounting for the dispensed fluid comprises transferring ownership of the dispensed fluid from the fluid supplier.

7. A system for distributing fluids as recited in claim 1, wherein accounting for the dispensed fluid comprises transmitting to the fluid supplier information about the dispensed fluid.

8. A system for distributing fluids as recited in claim 1, wherein accounting for the dispensed fluid comprises determining an amount of fluid remaining in the fluid container.

9. A system for distributing fluids as recited in claim 1, wherein accounting for the dispensed fluid comprises determining whether a machine using the dispensed fluid is operating normally.

10. In a relationship between a fluid supplier and a user, a method of distributing an industrial fluid, the method comprising:
providing at the user's location a transportable fluid container having contained therein an industrial fluid, wherein the transportable fluid container and the industrial fluid contained therein are owned by the fluid supplier;
allowing the user to dispense an amount of industrial fluid from the transportable fluid container;
as the amount of industrial fluid is being dispensed from the transportable fluid container, determining the amount of industrial fluid dispensed; and
accounting for the industrial fluid dispensed from the transportable container.

11. A method of distributing an industrial fluid as recited in claim 10, wherein providing at the user's location a transportable fluid container having contained therein an industrial fluid comprises transporting the transportable container to the user's location while the transportable container has contained therein the industrial fluid.

12. A method of distributing an industrial fluid as recited in claim 10, wherein the industrial fluid comprises a petroleum-based fluid.

13. A method of distributing an industrial fluid as recited in claim 10, wherein the industrial fluid comprises a lubricant for a vehicle.

14. A method of distributing an industrial fluid as recited in claim 10, wherein the industrial fluid comprises a cutting fluid.

15. A method of distributing an industrial fluid as recited in claim 10, wherein accounting for the industrial fluid dispensed from the transportable container comprises transferring from the fluid supplier ownership of the industrial fluid dispensed from the transportable container.

16. A method of distributing an industrial fluid as recited in claim 10, wherein accounting for the industrial fluid dispensed from the transportable container comprises billing the user for the industrial fluid dispensed from the transportable container.

17. A method of distributing an industrial fluid as recited in claim 10, wherein accounting for the industrial fluid dispensed from the transportable container comprises communicating to the fluid supplier information about the industrial fluid dispensed from the transportable container.

18. A method of distributing an industrial fluid as recited in claim 10, wherein accounting for the amount of industrial fluid dispensed from the transportable container comprises determining an amount of industrial fluid remaining in the transportable container.

19. A method of distributing an industrial fluid as recited in claim 18, wherein accounting for the amount of industrial fluid dispensed from the transportable container further comprises, if the amount of industrial fluid remaining in the container is less than a threshold value, recording an order for additional industrial fluid.

20. A method of distributing an industrial fluid as recited in claim 19, wherein recording an order for additional industrial fluid comprises recording an order for an additional transportable container having contained therein the additional industrial fluid.

21. In a relationship between a fluid supplier and a user, a method of distributing fluids, the method comprising:
providing a fluid distribution station at the user's location, the fluid distribution station being configured to be coupled with at least one fluid container;
providing at least one fluid container having disposed therein a fluid for distribution, the fluid being owned by the fluid supplier;
coupling the at least one fluid container with the fluid distribution station, such that the fluid distribution station and the fluid container are in fluid communication;
allowing the user to dispense an amount of fluid from the fluid container using the fluid distribution station;
as the fluid is being dispensed, determining with the fluid distribution station the amount of fluid dispensed from the fluid container; and
communicating to the fluid supplier information about the fluid dispensed from the fluid container.

22. A method of distributing fluids as recited in claim 21, further comprising transferring ownership of the dispensed fluid from the fluid supplier.

23. A method of distributing fluids as recited in claim 21, wherein the at least one fluid container is a plurality of fluid containers, each of the plurality of fluid containers having disposed therein a fluid for distribution, each of the fluids being owned by the fluid supplier.

24. A method of distributing fluids as recited in claim 21, wherein the fluid is a petroleum-based fluid.

25. A method of distributing fluids as recited in claim 21, further comprising determining an amount of fluid remaining in the fluid container based on the amount of fluid dispensed from the fluid container.

26. A method of distributing fluids as recited in claim 25, further comprising communicating to the fluid supplier the amount of fluid remaining in the fluid container.

27. A method of distributing fluids as recited in claim 21, wherein providing a fluid distribution station comprises leasing the fluid distribution station to the user.

28. A method of distributing fluids as recited in claim 21, wherein the fluid distribution station is mobile.

29. A method of distributing fluids as recited in claim 28, wherein the fluid distribution station comprises means for locomotion.

30. A method of distributing fluids as recited in claim 21, further comprising providing a control terminal in communication with the fluid distribution station, the control terminal being configured to receive data from the fluid distribution station about the fluid dispensed from the fluid container.

31. A method of distributing fluids as recited in claim 30, wherein communicating to the fluid supplier information about the fluid dispensed from the fluid container comprises:
transmitting from the fluid distribution station data about the fluid dispensed from the fluid container;
receiving at the control terminal the data about the fluid dispensed from the fluid container; and
transmitting from the control terminal to the fluid supplier the data about the fluid dispensed from the fluid container.

32. A method of distributing fluids as recited in claim 30, further comprising transmitting from the control terminal an authorization to dispense fluid from the fluid container.

33. A method of distributing fluids as recited in claim 32, wherein the authorization to dispense fluid from the fluid container specifies an amount of fluid to be dispensed.

34. A method of distributing fluids as recited in claim 32, further comprising transmitting from the fluid distribution station a request for an authorization to dispense fluid from the fluid container.

35. A method of dispensing an industrial fluid, the method comprising:
providing a fluid distribution station, the fluid distribution station being configured to be coupled with at least one fluid container;
coupling a transportable fluid container with the fluid distribution station, such that the fluid distribution station and the transportable fluid container are in fluid communication, the transportable fluid container having contained therein an industrial fluid owned by a fluid supplier;
dispensing an amount of fluid from the fluid container using the fluid distribution station;
as the fluid is being dispensed, determining with the fluid distribution station the amount of fluid dispensed from the fluid container;
transmitting to a computer remote from the fluid distribution station information about the fluid dispensed from the fluid container.

36. A method of dispensing an industrial fluid as recited in claim 35, further comprising:
coupled with a second container with the fluid distribution station; and
pressurizing the second container with a gas.

37. A method of dispensing an industrial fluid as recited in claim 36, further comprising:
dispensing the gas from the second container.

38. A method of dispensing an industrial fluid as recited in claim 36, wherein the gas serves as a source of pressure for dispensing the industrial fluid.

39. A fluid distribution station configured to dispense at least one fluid, the fluid distribution station comprising:
a connecting mechanism for providing fluid communication between the fluid distribution station and at least one transportable fluid container;
a fluid displacement mechanism configured to transfer an amount of fluid from the at least one transportable fluid container;
a fluid measurement device for measuring the amount of fluid transferred from the at least one transportable fluid container; and
a communication system operable to transmit information about the fluid transferred from the at least one transportable fluid container.

40. A fluid distribution station as recited in claim 39, wherein the fluid measurement device comprises a scale.

41. A fluid distribution station as recited in claim 39, wherein the fluid measurement device comprises an impulse flow meter.

42. A fluid distribution station as recited in claim 39, wherein the communication system comprises a radio-frequency antenna.

43. A fluid distribution station as recited in claim 39, further comprising a control system, the control system comprising a processor and instructions executable by the processor to receive from the fluid measurement device data about the fluid transferred from the at least one transportable fluid container.

44. A fluid distribution station as recited in claim 43, wherein the control system comprises further instructions executable by the processor to transmit to a control terminal via the communication system the data about the fluid transferred from the at least one transportable fluid container.

45. A fluid distribution station as recited in claim 43, wherein the control system comprises further instructions executable by the processor to receive from a control terminal an authorization to dispense an amount of fluid from the at least one transportable fluid container.

46. A fluid distribution station as recited in claim 39, wherein the fluid displacement mechanism operates using a pressurized gas.

47. A fluid distribution station as recited in claim 46, further comprising an attachment mechanism configured to provide fluid communication between an external source of pressurized gas and the at least one fluid container.

48. A fluid distribution station as recited in claim 46, wherein the fluid distribution station is configured to be in fluid communication with an additional container having contained therein a supply of pressurized gas, the fluid distribution station being operable to provide fluid communication between the additional container and the at least one transportable fluid container, such that the fluid displacement mechanism operates using the supply of pressurized gas.

49. In a relationship between a fluid supplier and a user, a transportable fluid container for delivering an industrial fluid from the fluid supplier to the user, the transportable fluid container being configured to contain therein an industrial fluid that may be dispensed by the user, the transportable fluid container being further configured to be placed in fluid communication with a fluid distribution station, such that the user may dispense a first amount of fluid from the transportable fluid container using the fluid distribution station, whereupon the first amount of fluid dispensed from the transportable fluid container may be measured and accounted for separately from a second amount of fluid remaining in the transportable fluid container, such that ownership of the first amount of fluid dispensed from the transportable fluid container can be transferred from the fluid supplier to the user, while ownership of the second amount of fluid remaining in the transportable fluid container remains with the fluid supplier.

50. A transportable fluid container as recited in claim 49, wherein the transportable fluid container is further configured to be transported using a general-purpose freight transport vehicle.

51. A transportable fluid container as recited in claim 49, wherein the transportable fluid container comprises a fluid displacement mechanism configured to be coupled to the fluid distribution station, thereby providing fluid communication between the transportable fluid container and the fluid distribution station, such that the fluid displacement mechanism is operable to dispense fluid from the transportable fluid container via the fluid distribution system.

52. A transportable fluid container as recited in claim 49, wherein the transportable fluid container is associated with an identifier, the identifier being configured to identify the fluid contained within the container.

53. In a relationship between a fluid supplier and a user, a computer software product for facilitating the distribution of industrial fluids, the computer software product being embodied on a computer readable medium and including instructions executable by a computer processor to:
receive information about a fluid being dispensed from a fluid distribution station;
determine the amount of fluid dispensed from the fluid distribution station;
transmit information about the dispensed fluid; and
account for the dispensed fluid.

54. A computer software product as recited in claim 53, wherein at least part of the computer software product is configured to be executed on a processor incorporated within a fluid distribution station.

55. A computer software product as recited in claim 53, wherein at least part of the computer software product is configured to be executed on a processor incorporated within a control terminal.

56. A computer software product as recited in claim 55, wherein the control terminal is located at a facility operated by the user,

57. A computer software product as recited in claim 53, wherein at least part of the computer software product is configured to be executed on a processor incorporated within a server operated by the fluid supplier.

58. A computer software product as recited in claim 53, wherein accounting for the dispensed fluid comprises transferring ownership of the dispensed fluid.
